(19) United States
(12) Patent Application Publication
(10) Pub. No.: US 2010/0219739 A1
(43) Pub. Date: Sep. 2, 2010

(54) LED LIGHT TUBE AND ITS CONNECTOR THEREOF

(75) Inventors: Cheng-Hsiung Kuo, Hsin-Tien City (TW); Hsuan-Hui Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: ENERGYLED CORPORATION, TAIPEI COUNTY (TW)

(21) Appl. No.: 12/700,783

(22) Filed: Feb. 5, 2010

(30) Foreign Application Priority Data
Feb. 27, 2009 (TW) 098203011

(51) Int. Cl. H01J 5/50

(52) U.S. Cl. 313/318.12

(57) ABSTRACT

A LED light tube and its connector thereof are revealed. Each of two ends of the LED light tube is disposed with a LED light tube connector. The LED light tube connector includes a rotating base, two connector pins, a cover and a housing. The two connector pins are disposed on one end of the rotating base. The rotating base includes a first location adjustment structure and the cover has a second location adjustment structure. The rotating base is mounted in the housing while the cover is fixed on the housing. The rotating base rotates relative to the cover as well as the housing optionally so as to adjust the assembling between the first and the second location adjustment structure. Thus the two connector pins change from a first position to a second position and light from the LED light tube emits in a desired direction.

### FIELDS OF THE INVENTION

The present invention relates to a light tube and its connector, especially to a light emitting diode (LED) light tube and connector thereof.

### DESCRIPTIONS OF RELATED ART

Along with the increasing of the living standard, lamps and decorative lighting have received more attention. Once the proper decorative lighting is applied to exterior or interior decoration, it provides not only practical utility but also environment beautification. Now the most common light source for decorative lighting is fluorescent lamp.

A fluorescent lamp is a gas-discharge lamp that uses electricity to excite mercury vapor. The lamp is filled with a gas containing mercury vapor formed by a few drops of mercury and argon. The pressure inside the lamp is around 0.3% of atmospheric pressure and mercury atoms are about one thousandth of the whole gas atoms. By applying current, the gas is excited to produce light. After long term use, dark marks are formed at the lamp ends. This is due to that electrodes are arranged at two ends of the fluorescent lamp and the electrodes are sputtered by collision of argon to form dark marks on lamp wall of two sides of the fluorescent lamp. When both ends of the fluorescent lamp become dark, the lamp is near the end of the life. The light emitted is reduced due to the deposition. Although the fluorescent lamp has an advantage of large light emitting area, it still has a number of shortcomings such as high power consumption and a short life.

In recent years, along with on-going development and broader applications of LED technology, LED related products have become daily essentials. LED emits light by a low-voltage high current way. Moreover, the LED features on long life, low power consumption and, lack of heat radiation. Due to above advantages, LED lighting has been developed for environmental friendliness.

However, LED is a high brightness lighting element with quite small volume. Thus the lighting area of the LED is limited to a small area. Thus when each LED emits light, the light is unable to be concentrated. In order to overcome such problem of LED lights, light scattering elements are applied so as to scatter light emitted from each LED.

Although the above problem has been solved, the LED lights available now still have other problems in use. Unlike omni-directional light from fluorescent lamps, light emitted from LED lights is directional. And the two connector pins on two ends of a LED light tube may be not aligned with lighting direction of the LED light tube. Thus light from the LED may not emit in a desired direction when the LED light tube is mounted on a light holder. Therefore efficiency of the LED light tube is reduced. There is a need to provide a novel LED light tube and connectors thereof in which two connector pins are rotatable so as to adjust lighting direction of the LED light tube and improve LED light efficiency.

### SUMMARY OF THE INVENTION

Therefore it is a primary object of the present invention to provide a LED light tube and its connector thereof. A LED light tube connector is disposed on each of two ends of the LED light tube. By rotation of a rotating base, an angular position of two connector pins of the LED light tube is changed so as to make light from the LED light tube emit in a desired direction when the LED light tube is mounted on a light holder.

In order to achieve above object, the present invention provides a LED light tube and its connector thereof. The connector of the LED light tube (LED light tube connector) consists of a rotating base, two connector pins, a cover and a housing. The two connector pins are disposed on one end of the rotating base. The rotating base includes a first location adjustment structure while the cover is arranged with a second location adjustment structure and is arranged over the other end of the rotating base. The first location adjustment structure is assembled with the second location adjustment structure correspondingly. The housing is disposed on one end of the LED light tube, and the rotating base is mounted in the housing while the cover is fixed on the housing. The rotating base rotates relative to the cover as well as the housing optionally so as to adjust the assembling between the first location adjustment structure and the second location adjustment structure. Thus the two connector pins change from a first position to a second position and light from the LED light tube emits to a desired direction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing a using state of an embodiment according to the present invention;

FIG. 2 is a perspective view of an embodiment according to the present invention;

FIG. 3 is a cross sectional view of an embodiment according to the present invention;

FIG. 4 is an explosive view of an embodiment according to the present invention;

FIG. 5 is a perspective view of another embodiment according to the present invention;

FIG. 6 is a cross sectional view of another embodiment according to the present invention;

FIG. 7 is an explosive view of another embodiment according to the present invention.

### DETAILED DESCRIPTION OF THE PREFERRED EMBODIMENT

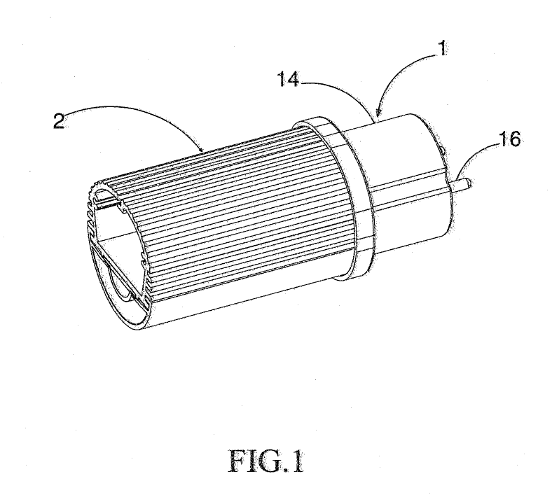

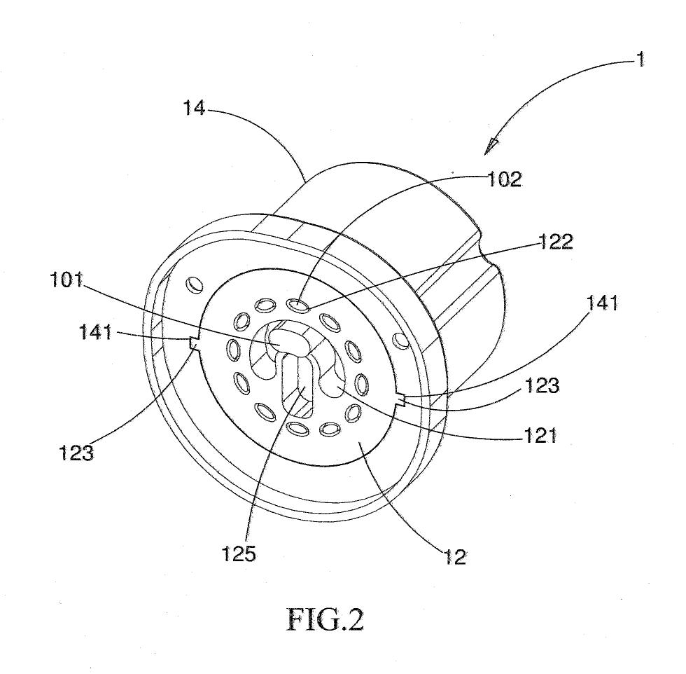

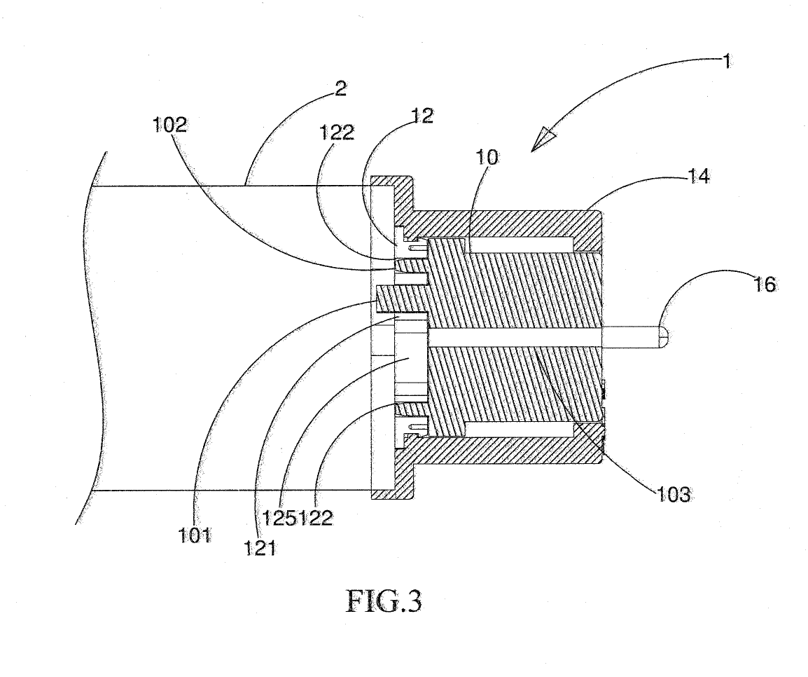

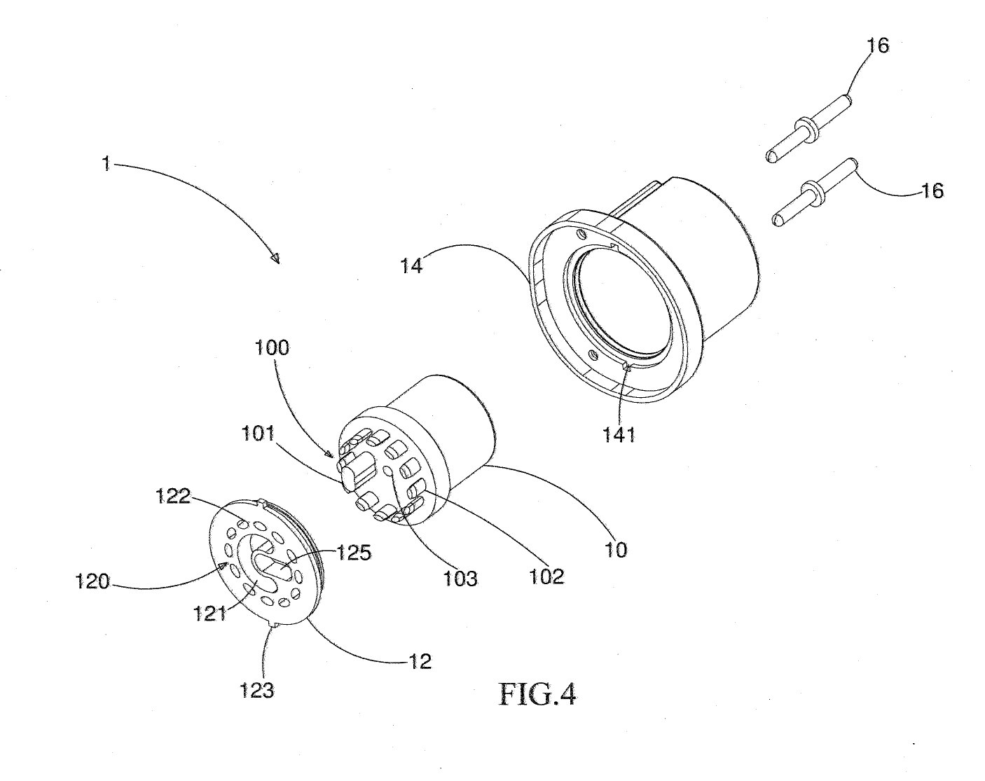

Refer from FIG. 1 to FIG. 4, an embodiment of the present invention is revealed. As shown in figure, a rotatable LED light tube connector 1 of the present invention includes a rotating base 10, a cover 12, a housing 14 and two connector pins 16. The rotating base 10 includes a first location adjustment structure 100 and the cover 12 has a second location adjustment structure 120. The first location adjustment structure 100 is assembled with the second location adjustment structure 120 correspondingly. The first location adjustment structure 100 of this embodiment consists of an adjustment member 101 and a plurality of locating members 102. The second location adjustment structure 120 is composed of an adjustment slot 121 and a plurality of locating holes 122. The cover 12 is disposed on one end of the rotating base 10 that is with the adjustment member 101. The adjustment member 101 of the rotating base 10 inserts into the adjustment slot 121 of the cover 12 and the adjustment member 101 slides in the adjustment slot 121 suitably and those locating members 102 are arranged in a circular arrangement. Similarly, those locating holes 122 corresponding to the locating members 102 of the rotating base 10 are arranged circularly. Those locating members 102 respectively insert into the locating holes 122 correspondingly. The rotating base 10 is sleeved into the housing 14 whose one end near the cover 12 is arranged with a plurality of locking grooves 141. A plurality of fixing members 123 fitted correspondingly to the plurality of locking grooves 141 of the housing 14 is arranged at the cover 12. Thus the cover 12 is fixed on the housing 14 by the plurality of fixing members 123 of the cover 12 locking with the plurality of locking grooves 141 of the housing 14.

One end of the LED light tube connector 1 with the cover 12 is arranged at one end of a LED light tube 2. A center of the rotating base 10 and of the cover 12 respectively is disposed with a penetrating hole 103, 125. An electrical line (not shown in figure) of the LED light tube 2 passes through the penetrating hole 125 of the cover 12 and the penetrating hole 103 of the rotating base 10 in turn. The two connector pins 16 are set on one end of the rotating base 10 and are connected with the electrical line of the LED light tube 2 for receiving an external AC (alternating current) input voltage. When the LED light tube 2 is mounted on a light holder, the rotating base 10 rotates relative to the cover 12 as well as the housing 14 to adjust the assembling between the first location adjustment structure 100 and the second location adjustment structure 120. That means the adjustment member 101 of the rotating base 10 slides inside the adjustment slot 121 of the cover 12. Thus the two connector pins 10 changes from a first position to a second position. Therefore light from the LET) light tube 2 emits in a desired direction while being assembled on a light holder.

The assembling of the adjustment member 101 with the adjustment slot 121 is a close interference fit. By applying an external force, users can rotate the adjustment member 101 to make the adjustment member 101 slide inside the adjustment slot 121. Thus the assembly of the adjustment member 101 with the adjustment slot 121 is changed. A rotation angle of the adjustment slot 121 of the cover ranges from 0 to 180 degrees. This is in order to avoid twisting and bending of the line of the LED light tube 2. The twisting and bending of the line occur when the rotating base 10 rotates over 180 degrees while the over-rotation of the rotating base 10 is due to that the rotation angle of the adjustment slot 121 of the cover 12 is over 180 degrees. Moreover, the locating members 102 of the rotating base 10 of the LED light tube connector 1 respectively insert into the locating holes 122 of the cover 12 correspondingly so as to prevent users from adjusting the positions of the connector pins 16 carelessly while rotating the rotating base 10. Furthermore, figure one only shows the LED light tube connector 1 of the present invention is disposed on one end of the LED light tube 2. Similarly, the other end of the LED light tube 2 can also be arranged with the rotatable LED light tube connector 1 of the present invention so as to rotate two connector pins on the other end of the LED light tube 2.

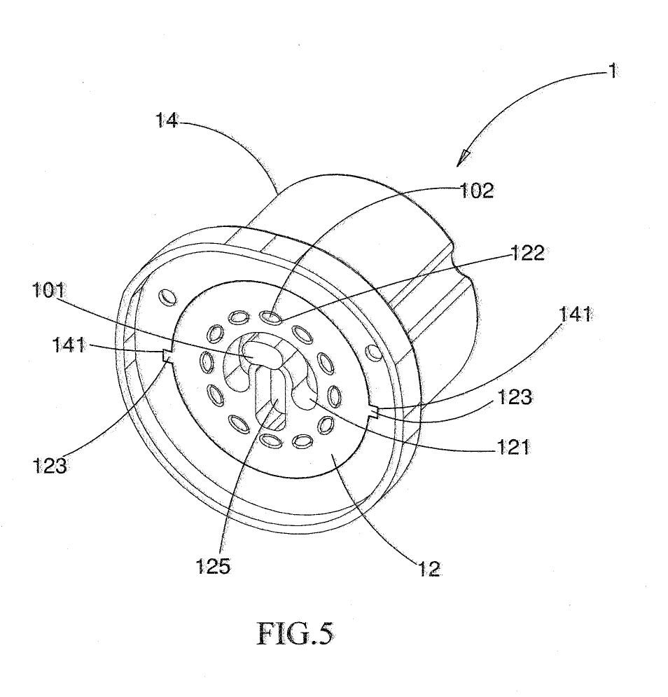

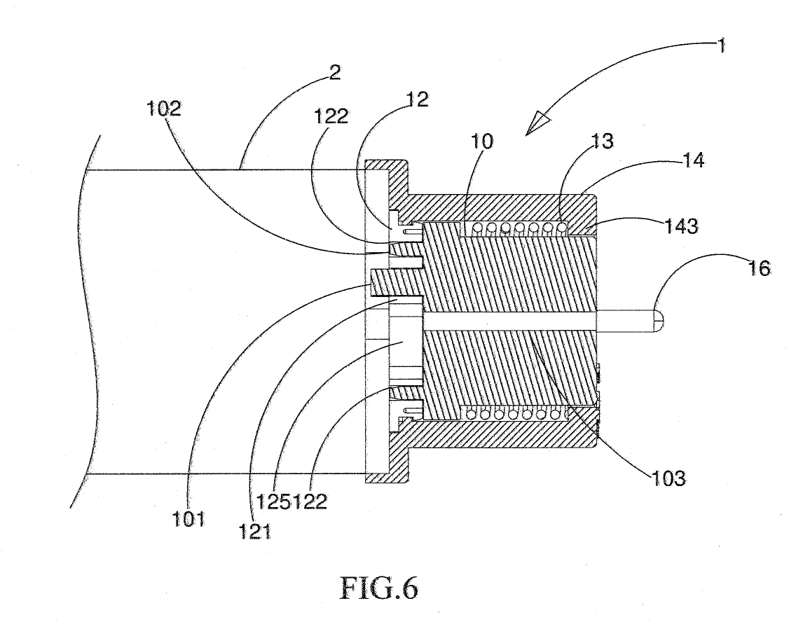

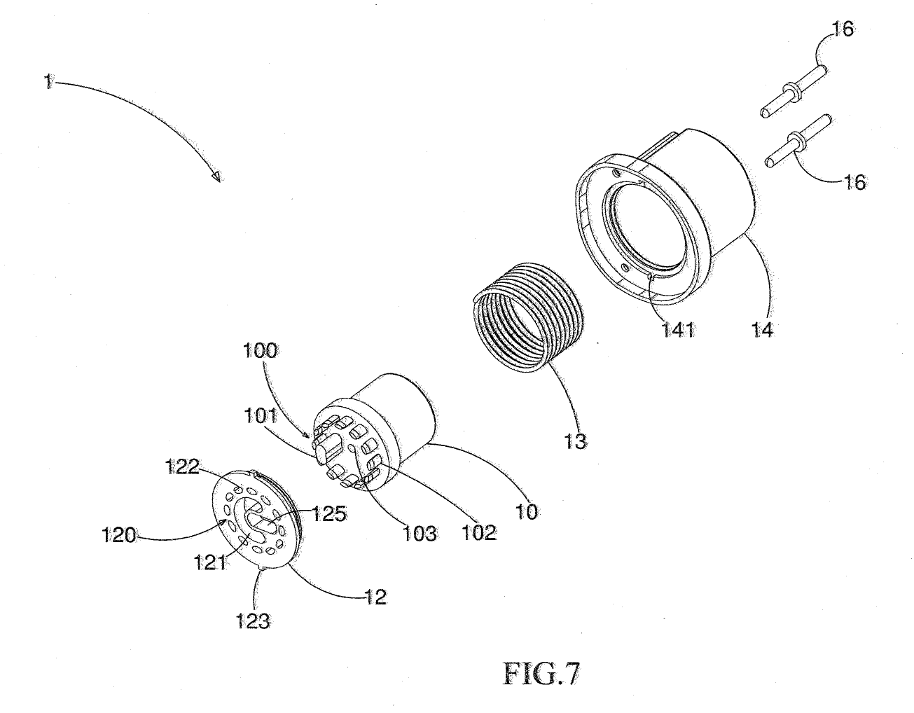

Refer from FIG. 5 to FIG. 7, another embodiment of the present invention is disclosed. As shown in figure, besides a rotating base 10, a cover 12, a housing 14 and connector pins 16, the LED light tube connector 1 further includes an elastic element 13. The elastic element 13 is sleeved onto one end of the rotating base 10 without the cover 12. The rotating base 10 is sleeved into the housing 14 whose bottom end is arranged with a retaining part 143. The retaining part 143 is for preventing the elastic element 13 from falling out of the housing 14. The fixing members 123 of the cover 12 are locked with the locking grooves 141 of the housing 14 so as to fix the cover 12 on the housing 14.

Moreover, similar to the above embodiment, one end of the LED light tube connector 1 in this embodiment disposed with the cover 12 is disposed at one end of a LED light tube 2. A center of the rotating base 10 and of the cover 12 respectively is disposed with a penetrating hole 103, 125. An electrical line of the LED light tube 2 passes through the penetrating hole 125 of the cover 12 and the penetrating hole 103 of the rotating base 10 in sequence. The two connector pins 16 are arranged at one end of the rotating base 10 without the cover 12 and are connected with the line of the LED light tube 2 so as to receive an external AC (alternating current) input voltage.

When the LED light tube 2 of this embodiment is assembled on a light holder and the angular position of the connector pins 16 are required to be adjusted for correct emitting direction of the LED light tube 2, firstly one end of the rotating base 10 with two connector pins 16 is pulled out of the housing 14 so as to release the locating members 102 of the rotating base 10 from the locating holes 122. Then rotate the rotating base 10 so that the adjustment member 101 slides inside the adjustment slot 121 and the two connector pins 16 change from a first position to a second position. Thus light from the LED light tube 2 emits in a right direction. Once the angle of the rotating base 10 has been adjusted, the rotating base 10 turns back to the housing 14 due to elasticity of the elastic member 13. Thus the positions of the connector pins 16 are fixed. The locating members 102 of the rotating base 10 respectively lock into the locating holes 122 of the cover 12 correspondingly so as to prevent users from rotating the rotating base 10 carelessly and causing the positional change of the two connector pins 16 from the first position to the second position. The same with the above embodiment, the rotation angle of the adjustment slot 121 of the cover 12 in this embodiment ranges from 0 to 180 degrees so as to prevent twisting and bending of the line of the LED light tube 2 that may occur when the rotation angle of the adjustment slot 121 of the cover 12 is over 180 degrees.

In summary, a LED light and connectors thereof according to the present invention includes a LED light tube and LED light tube connector arranged at the LED light tube. The LED light tube connector consists of a rotating base. An angular position of two connector pins is changed by rotation of the rotating base so as to make light from the LED light tube emit in a desired direction when the LED light tube is mounted on a light holder. The rotating base of the LED light tube connector is disposed with an adjustment member while a cover is arranged with an adjustment slot. The adjustment member inserts the adjustment slot and slides in the adjustment slot. A rotation angle of the adjustment slot is no more than 180 degrees so as to avoid twisting and bending of electrical lines of the LED light tube. A plurality of locating members is arranged at the rotating base of the LED light tube connector. Similarly, a plurality of locating holes corresponding to the locating members is disposed on the cover. Those locating members respectively insert into the locating holes correspondingly for preventing users from changing the angle of the two connector pins carelessly while rotating the rotating base.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A LED light tube disposed with a LED light tube connector on each of two ends thereof and the LED light tube connector comprising:
a rotating base having a first location adjustment structure;
two connector pins disposed on one end of the rotating base and connected with an electrical line of the LED light tube;
a cover arranged with a second location adjustment structure that is assembled with the first location adjustment structure of the rotating base correspondingly; and
a housing disposed on one end of the LED light tube while the rotating base is mounted in the housing and the cover is fixed on the housing;
wherein the rotating base rotates relative to the cover as well as the housing optionally so as to adjust the assembling between the first location adjustment structure and the second location adjustment structure and further change an angular position of the two connector pins from a first position to a second position.

2. The LED light tube as claimed in claim 1, further comprising:
an elastic element disposed between the rotating base and the housing.

3. The LED light tube as claimed in claim 2, wherein the housing is arranged with a retaining part that is used to retain the elastic element.

4. The LED light tube as claimed in claim 1, wherein the first location adjustment structure includes an adjustment member and a plurality of locating members, and the second location adjustment structure includes an adjustment slot and a plurality of locating holes; the adjustment member inserts into the adjustment slot and slides in the adjustment slot suitably while the locating members respectively corresponding to and insert into the locating holes.

5. The LED light tube as claimed in claim 2, wherein the first location adjustment structure includes an adjustment member and a plurality of locating members, and the second location adjustment structure includes an adjustment slot and a plurality of locating holes; the adjustment member inserts into the adjustment slot and slides in the adjustment slot suitably while the locating members respectively corresponding to and insert into the locating holes.

6. The LED light tube as claimed in claim 4, wherein a rotation angle of the adjustment slot ranges from 0 to 180 degrees.

7. The LED light the as claimed in claim 4, wherein the locating members and the locating holes respectively are arranged in a circular arrangement.

8. The LED light tube as claimed in claim 1, wherein the cover is disposed with a plurality of fixing members around thereof and the housing is arranged with a plurality of locking grooves, and the fixing members are fitted correspondingly to the locking grooves.

9. The LED light tube as claimed in claim 1, wherein a penetrating hole is located at a center of the cover as well as of the rotating base respectively and the electrical line of the LED light tube passes through the penetrating hole of the cover and the penetrating hole of the rotating base.

10. A LED light tube connector disposed on each of two ends of a LED light tube comprising:
a rotating base having a first location adjustment structure,
two connector pins disposed on one end of the rotating base and connected with an electrical line of the LED light tube;
a cover arranged with a second location adjustment structure that is assembled with the first location adjustment structure of the rotating base correspondingly; and
a housing disposed on one end of the LED light tube while the rotating base is mounted in the housing and the cover is fixed on the housing;
wherein the rotating base rotates relative to the cover as well as the housing optionally so as to adjust the assembling between the first location adjustment structure and the second location adjustment structure and further change an angular position of the two connector pins from a first position to a second position.

11. The LED light tube connector as claimed in claim 10, wherein the LED light tube further comprising:
an elastic element disposed between the rotating base and the housing.

12. The LED light tube connector as claimed in claim 11, wherein the housing is arranged with a retaining part that is used to retain the elastic element.

13. The LED light tube connector as claimed in claim 10, wherein the first location adjustment structure includes an adjustment member and a plurality of locating members, and the second location adjustment structure includes an adjustment slot and a plurality of locating holes; the adjustment member insert, the adjustment slot and slides in the adjustment slot suitably while the locating members respectively corresponding to and insert into the locating holes.

14. The LED light tube connector as claimed in claim 11, wherein the first location adjustment structure includes an adjustment member and a plurality of locating members, and the second location adjustment structure includes an adjustment slot and a plurality of locating holes; the adjustment member inserts into the adjustment slot and slides in the adjustment slot suitably while the locating members respectively corresponding to and insert into the locating holes.

15. The LED light tube connector as claimed in claim 13, wherein a rotation angle of the adjustment slot ranges from 0 to 180 degrees.

16. The LED light tube connector as claimed in claim 13, wherein the locating members and the locating holes respectively are arranged in a circular arrangement.

17. The LED light tube connector as claimed in claim 10, wherein the cover is disposed with a plurality of fixing members around thereof and the housing is arranged with a plurality of locking grooves, and the fixing members are fitted correspondingly to the locking grooves.

18. The LED light tube connector as claimed in claim JO, wherein an penetrating hole is located at a center of the cover as well as of the rotating base respectively and the electrical line of the LED light tube passes through the penetrating hole of the cover and the penetrating hole of the rotating base.
